(19) United States
(12) Patent Application Publication
(10) Pub. No.: US 2018/0255762 A1
(43) Pub. Date: Sep. 13, 2018

(54) LIGHT SOURCE WITH INTEGRAL SONIC PEST REPELLING DEVICE

(71) Applicant: Eric Rubel, Westfield, NJ (US)

(72) Inventor: Eric Rubel, Westfield, NJ (US)

(21) Appl. No.: 15/918,534

(22) Filed: Mar. 12, 2018

Related U.S. Application Data
(60) Provisional application No. 62/469,909, filed on Mar. 10, 2017.

(51) Int. Cl. A01M 29/18; F21V 23/04; F21K 9/232; F21K 9/238; F21K 9/237; B06B 1/02; G10K 11/00

(52) U.S. Cl. CPC A01M 29/18; F21V 23/04; F21K 9/232; F21K 9/238; F21Y 2115/10; F21V 23/0464; B06B 1/0207; G10K 11/004; F21K 9/237

(57) ABSTRACT

A light source suitable for use in a conventional light socket of a conventional light fixture includes an integral sonic repelling device operable to generate sound at a frequency that is inaudible to humans but that repels pests such as mice and rats.

### CROSS-REFERENCE TO RELATED APPLICATIONS

This application is the U.S. Non-Provisional Patent Application of U.S. Provisional Application No. 62/469,909, filed Mar. 10, 2017, the entire contents of each of which are incorporated by reference herein.

### BACKGROUND

### Field of the Disclosure

The present invention relates to a light source suitable for use in a light socket that includes an integral sonic pest repelling device operable to emit sound at a frequency that repels pests such as mice and rats.

### Related Art

Sonic repelling devices are known in the art and typically plug into a wall outlet. These devices are operable to transmit sound at a frequency that is generally inaudible to humans but is unpleasant to pests such as mice and rats. As a result, these sonic repelling devices serve as a deterrent to infestation by pests. These devices have a few drawbacks. First, since these sonic repelling devices are usually mounted in an electrical socket, they prevent other devices from being plugged into these sockets. In addition, since electrical sockets are typically mounted close to the floor and are often hidden behind furniture, the range of the sound emitted from these devices is limited and unreliable. Finally, since these devices typically require an outlet, they cannot be used in areas that may be attractive to pests, but do not include power outlets.

Accordingly, it would be desirable to provide a sonic repelling device with more flexibility and ease of use.

### SUMMARY

It is an object of the present disclosure to provide a light source suitable for use in a conventional light socket and including an integral sonic repelling device that emits sound at a frequency that repels pests such as mice and rats.

A light element in accordance with an embodiment of the present disclosure includes a body, a connector mounted on the body and operable to connect the light element to a power source, at least one light emitting element connected to the body and operable to provide visible light, at least one pest repelling element connected to the body, the pest repelling element including at least one speaker operable to provide sound at a predetermined frequency and a switch operable to selectively activate the at least one light emitting element and the at least one pest repelling element.

A light element in accordance with another embodiment of the present disclosure includes a body, a connector mounted on the body and operable to connect the light element to a power source, at least one light emitting element connected to the body and operable to provide visible light, at least one pest repelling element connected to the body, the pest repelling element including at least one speaker operable to provide sound at a predetermined frequency and a controller operable to selectively activate the at least one light emitting element and the at least one pest repelling element.

Other features and advantages of the present invention will become apparent from the following description of the invention which refers to the accompanying drawings.

### BRIEF DESCRIPTION OF THE DRAWINGS

The above and related objects, features and advantages of the present disclosure will be more fully understood by reference to the following, detailed description of the preferred, albeit illustrative, embodiment of the present invention when taken in conjunction with the accompanying figures, wherein:

FIG. 1 is an exemplary illustration of a light source in accordance with an embodiment of the present disclosure;

FIG. 2 illustrates a more detailed view of the light source of FIG. 1 in which certain internal element are visible;

FIG. 3 is a view of the top end of the light source of FIG. 1;

FIG. 4A is an exemplary block diagram of a light source in accordance with an embodiment of the present disclosure; and

FIG. 4B is another exemplary block diagram of a light source in accordance with an embodiment of the present disclosure.

### DETAILED DESCRIPTION OF THE EXEMPLARY EMBODIMENTS

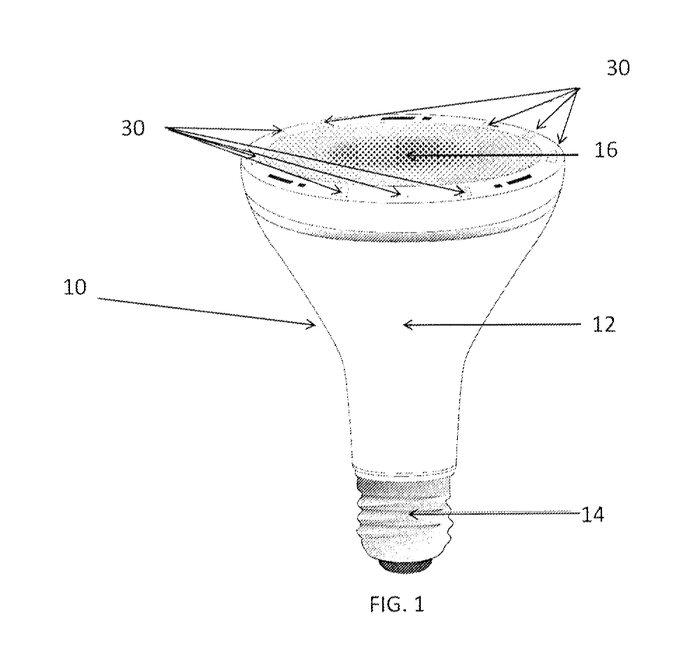

FIG. 1 illustrates a light source 10 in accordance with an embodiment of the present disclosure. As illustrated, the light source 10 generally includes a body 12 that is shaped like a conventional lightbulb. In particular, the body 12 of FIG. 1 generally conforms to the shape of a flood light type lightbulb of the type typically used for lighting up relatively large areas, for example, in front of a garage. The body 12 preferably includes a connector 14 suitable for insertion into a conventional Edison style light socket such that the light source 10 may be mounted in and operable with a conventional light socket. While the connector 14 of FIG. 1 is illustrated as being compatible with a conventional Edison style type socket, the light source 10 is preferably usable in any conventional socket such that the shape of the connector 14 may be altered for use in other types of sockets, if desired, for example, to include bayonet type connectors.

As noted above, the body 12 is preferably shaped in a manner similar to an existing flood light type lightbulb. As a result, the light source 10 is compatible with a variety of light fixtures that accept flood light type lightbulbs. Alternatively, the body 12 may be modified in shape to conform to the shape of a smaller lightbulb, for example, those suitable for use in an indoor lamps or other fixtures. As a result, the light source 10 will essentially be interchangeable with any conventional lightbulb and will fit into existing light fixtures easily and attractively. For example, the body 12 may be shaped to conform to the shape of a 60, 75 or 100 watt light bulb of the type commonly used in indoor lamp and light fixtures. It is noted that the body 12 need not be exactly the same as these other lightbulbs, but rather be sized and shaped to generally conform to their design such that the light source 10 may be used interchangeably with these other lightbulbs in lighting fixtures. This also includes relatively recently introduce CFL and LED lightbulbs. Regardless of the shape, the body 12 is preferably made of an opaque material, which may be, but is not limited to, plastic. In addition, the body 12 is preferably made of a relatively durable and weather resistant material such that the light source 10 is suitable for both indoor and outdoor use.

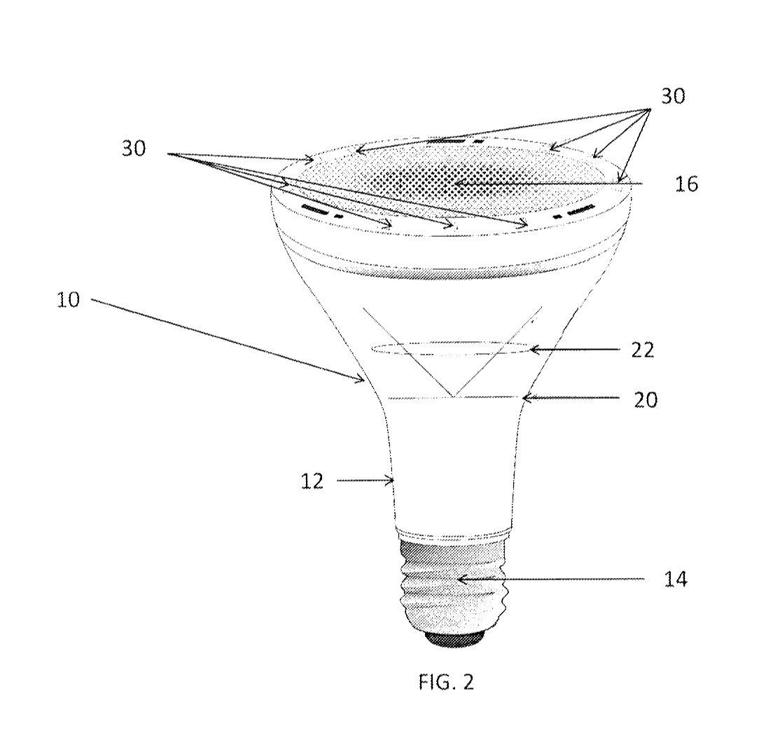

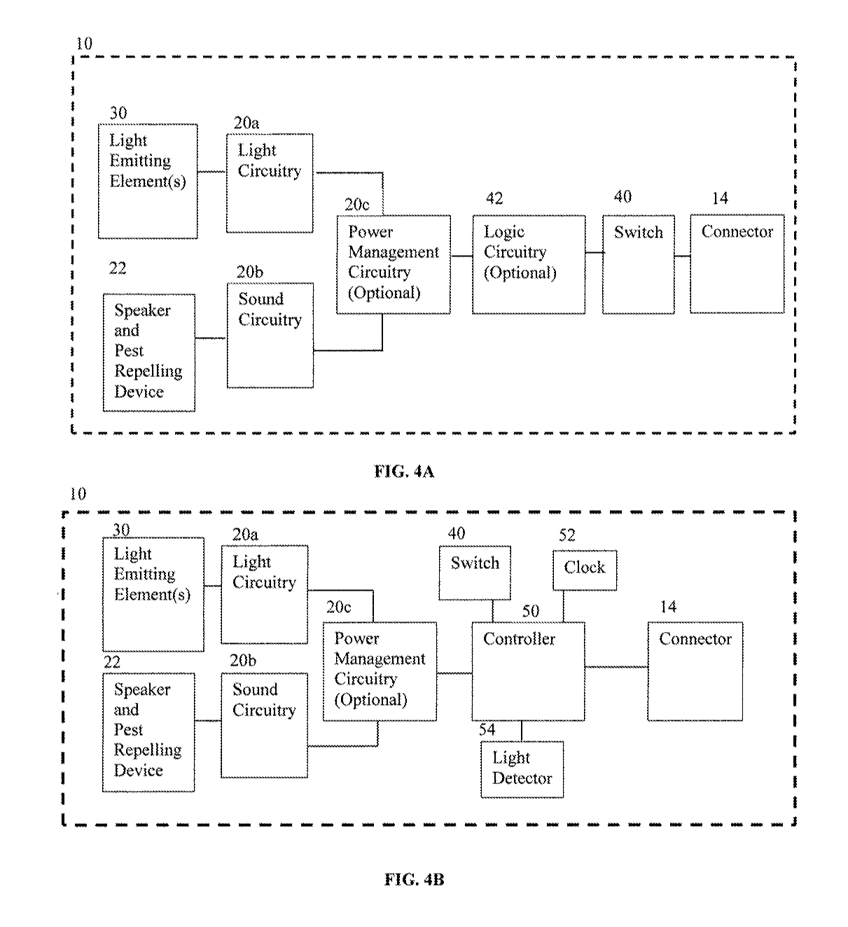

FIG. 2 illustrates a more detailed view of the interior of the body 12. In particular, the body 12 preferably houses circuitry, illustrated in FIG. 2 generally as the printed circuit board (PCB) 20. The circuitry preferably includes lighting circuitry 20a (see FIGS. 4A-4B, for example) as well as sound circuitry 20b (see FIGS. 4A-4B) for generating sound to repel pests. While FIG. 2 illustrates the circuitry embodied as the PCB 20, it is noted that suitable circuitry need not be mounted on a PCB but may be supplied in any desired manner. If desired, a second, or additional PCB may be provided with different circuitry provided on each PCB if desired. A transducer (speaker) 22 is preferably mounted in the housing 12 as well. The speaker 22 is preferably connected to and driven by the sound circuitry 20b. The speaker 22 may be connected to dedicated sound circuitry where no PCB is provided. The sound circuitry 20b drives the speaker 22 to generate sound at a frequency that is generally inaudible to humans but causes pain or irritation in pests such as mice and rats. That is, the speaker 22 acts as a pest repelling element when driven by the sound circuitry 20b. Such sounds are often called ultrasonic since they are beyond the range of human hearing. In a preferred embodiment, the speaker 22 generates sounds in the range of 32-62 kHz. While the term “speaker” is used herein, any suitable device that is capable of producing sound in the desired range of 32-62 kHz may be used. In one non-limiting example, a vibrating metal disk or plate may be used. As illustrated, all of these elements are integrated into the body 12 such that the light source 10 can be used in existing light fixtures without the need for modification.

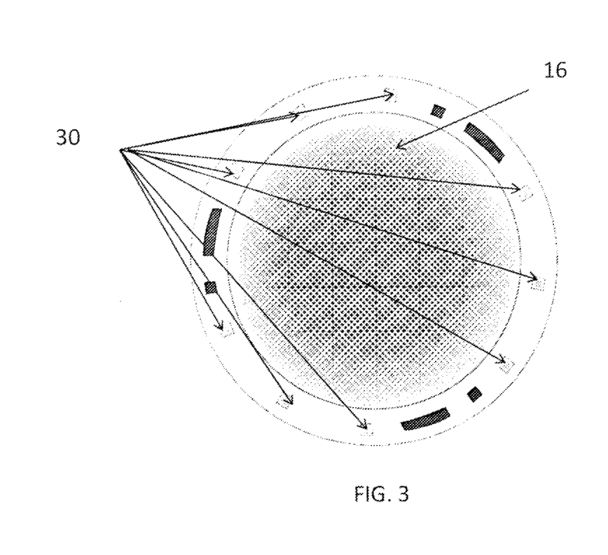

The speaker 22 has a general cone shape as illustrated in FIG. 3, however, any suitable speaker shape may be used. A speaker cover 16 may be provided on the end of the housing 12 opposite the connector 14 to protect the speaker 22 while allowing sound to be transmitted outside of the housing. The speaker cover 16 is shown in more detail in FIG. 3. The speaker cove 16, however, is not limited to the specific appearance illustrated in FIG. 3, but may be of any desired shape or design to protect the speaker 22 while allowing sound to pass through or around it.

A plurality of light emitting elements 30 are preferably mounted around an outer edge of the speaker cover 16 on the end of the housing 12. In a preferred embodiment, each of the light emitting elements 30 is embodied as a light emitting diode (LED). However, any suitable light emitting element may be used in place of LEDs. While nine light emitting elements 30 are shown in the figures, fewer or more light emitting elements may be used. The light emitting elements 30 are preferably connected to the PCB 20 which includes lighting circuitry 20a to control the on/off state of the light emitting elements 30. Alternatively, where no PCB is used, independent lighting circuitry 20a may be provided to control the light emitting elements 30. While the light emitting elements 30 are illustrated as being arranged around an outer edge of the speaker cover 16, there are not limited to placement in these positions but may be provided in any suitable position to provide visible light.

Power is provided to the PCB 20 and ultimately to the speaker 22 and light emitting elements 30 from the connector 14, which is connected to a conventional light socket. In an embodiment, one or more conductors may be provided between connector 14 and the PCB 20, and/or the circuits 20a, 20b, 20c. Any suitable connection between the connector 14 and the PCB 20, or other circuitry, may be used to provide power. As noted above, it is not necessary to use the PCB, in which case power may be provided directly to the light circuitry 20a and sound circuitry 20b. If necessary, or desired, power management circuitry 20c (see FIG. 4) may be provided on the PCB or independently, to provide suitable power for driving the speaker 22 and activating the light emitting elements 30.

In a preferred embodiment, the light source 10 operates in at least three different states. In the “off state,” none of the speaker 22 and the light emitting elements 30 are activated such that no light is emitted and no sound is generated. In a “first on state,” the speaker 22 and light emitting elements 30 are activated such that the light source 10 emits light via the light emitting elements 30, as well as sound from the speaker 22 to repel pests. In a “second on state,” the light source 10 emits sound via the speaker 22, however, does not emit light via the light emitting elements 30. The “second on state” may be useful during the day when light is unnecessary, but it is still desirable to provide sound to repel pests. If desired, a “third on state” may be provided in which the light emitting elements 30 are activated without the speaker 22, however, in general, it is preferable to have the speaker 22 activated whenever the light emitting elements 30 are activated.

In an embodiment, a switch 40 (see FIGS. 4A-4B) may be provided to change the state of the light source 10. The switch 40 may be a three way switch, toggle switch or any other suitable switch. In embodiments, logic circuitry 42 (see FIG. 4A) may be provided on the PCB 20 or elsewhere to allow for soft switching between these states. The logic circuitry 42 may respond to input provided via the switch 40 to change state. Where the switch 40 is a three way switch, the logic circuitry 42 may be unnecessary.

In embodiments, the state of the light source 10 may depend on more than switch position. For example, time of day and ambient light level may be used to determine or help determine the state of the light source. In such embodiments, the light source 10 preferably includes a clock or other timing element 52 as well as a light detector 54 (see FIG. 4B). These devices, as well as switch 40, if desired, may be used to determine the state of the light source. In this embodiment, a controller 50 (see FIG. 4B), such as a processor, may be provided in the housing 12 to control the light source 10 based on input provided from the switch 40, clock 52 and light sensor 54. For example, where the switch 40 indicates the “first on state,” but either the clock 52 or the light sensor 54 indicate that it is not yet night, or at least not sufficiently dark to merit activation of the light emitting elements 30, only the speaker 22 will be activated such that the light source 10 will be operating in the “second on state.” Thereafter, based on the time, lighting conditions, or both, the light emitting elements 30 will be activated once the time passes a predetermined time or the light level drops below a predetermined level. An additional position may be provided on the switch to allow for an automatic mode in which the speaker 22 is generally always activated and the light emitting elements 30 are activated and deactivated based on time of day and/or ambient light level. In an embodiment, when the switch 40 indicates the “off state,” this overrides the effect of the other devices such that the light emitting elements 30 and speaker 22 remain off regardless of time or light level.

The light source 10 of the present disclosure provide many benefits. First, it allows for sonic repelling of pests in areas that do not have electrical outlets. Second, since light fixtures are typically suspended well above the ground, the range of the sound emitted by the light source 10 is extended and more consistent as it is not blocked or deflected by immediately adjacent furniture. Further, by shaping the light source 10 to conform with the shape of conventional lightbulbs, the light source can turn virtually any light fixture into an insect repelling device without sacrificing the ability to provide needed light when desired.

Although the present invention has been described in relation to particular embodiments thereof, many other variations and modifications and other uses will become apparent to those skilled in the art.

What is claimed is:

1. A light source comprising:
a body;
a connector mounted on the body and operable to connect the light element to a power source;
at least one light emitting element connected to the body and operable to provide visible light;
at least one pest repelling element connected to the body, the pest repelling element including at least one speaker operable to provide sound at a predetermined frequency;
a switch operable to selectively activate the at least one light emitting element and the at least one pest repelling element.

2. The light source of claim 1, wherein the body is has a shape of a conventional flood light lightbulb.

3. The light source of claim 1, wherein the body has a shape of a conventional incandescent lightbulb.

4. The light source of claim 1, further comprising:
lighting circuitry mounted in the body and connected to the connector and the at least one light emitting element to control activation of the at least one light emitting element.

5. The light source of claim 4, further comprising:
sound circuitry mounted in the body and connected to the connector and the pest repelling element to control the pest repelling element.

6. The light source of claim 5, wherein the lighting circuitry and the sound circuitry are provided on a printed circuit board.

7. The light source of claim 5, wherein the lighting circuitry is provided on a first printed circuit board and the sound circuitry is provided on a second printed circuit board.

8. The light source of claim 5, further comprising power management circuitry connected to the connector and to the lighting circuitry and the sound circuitry and operable to provide power thereto.

9. The light source of claim 8, wherein the power management circuitry is provided on a printed circuit board.

10. The light source of claim 8, wherein lighting circuitry is provided on a first printed circuit board, the sound circuitry is mounted on a second printed circuit board and the power management circuitry is mounted on a third printed circuit board.

11. The light source of claim 1, wherein the switch is operable to activate the at least one light emitting element only, the at least one pest repelling element only or the at least one light emitting element and the pest repelling element at the same time.

12. The light source of claim 1, wherein the switch includes a plurality of switch positions, wherein the first switch position activates the at least one light emitting element and the pest repelling element at the same time and a second switch position activates the at least one pest repelling element only.

13. The light source of claim 1, wherein the body is made of a durable material.

14. The light source of claim 1, wherein the predetermined frequency is an ultrasonic frequency that is not audible to human ears.

15. The light element of claim 1, wherein the predetermined frequency is in the range of 32-62 kHz.

16. The light element of claim 1, wherein the at least one light element comprises at least one light emitting diode.

17. A light source comprising:
a body;
a connector mounted on the body and operable to connect the light element to a power source;
at least one light emitting element connected to the body and operable to provide visible light;
at least one pest repelling element connected to the body, the pest repelling element including at least one speaker operable to provide sound at a predetermined frequency;
a controller operable to selectively activate the at least one light emitting element and the at least one pest repelling element.

18. The light source of claim 17, further comprising a switch, wherein the controller controls the at least one light emitting element and the at least one pest repelling element based on an input provided by the switch.

19. The light source of claim 17, further comprising:
a clock operable to provide an indication of time of day; and
a light detector operable to provide an indication of an ambient light level, wherein the controller controls the at least one light emitting element and the at least one pest repelling element based on at least one of the time of day and the ambient light level.

20. The light source of claim 17, wherein the body has a shape of an incandescent lightbulb.
